(19) United States
(12) Patent Application Publication
(10) Pub. No.: US 2009/0133798 A1
(43) Pub. Date: May 28, 2009

(54) PROCESS FOR PRODUCING WIRE FOR BEAD CORD, BEAD CORD, AND VEHICLE TIRE

(75) Inventors: Hiroshi Sasabe, Utsunomiya-shi (JP); Hitoshi Wakahara, Utsunomiya-shi (JP); Yuichi Sano, Utsunomiya-shi (JP); Kenichi Okamoto, Itami-shi (JP)

Correspondence Address: OSHA LIANG L.L.P., TWO HOUSTON CENTER, 909 FANNIN, SUITE 3500, HOUSTON, TX, 77010, US

(73) Assignees: SUMITOMO (SEI) STEEL WIRE CORP., Itami-shi, Hyogo (JP); SUMITOMO ELECTRIC TOCHIGI CO., LTD., Utsunomiya-shi, Tochigi (JP)

(21) Appl. No.: 12/064,331

(22) PCT Filed: Apr. 16, 2007
(86) PCT No.: PCT/JP2007/058267

§ 371 Date: Feb. 20, 2008

(30) Foreign Application Priority Data
Apr. 20, 2006 (JP) 2006-116856
Apr. 9, 2007 (JP) 2007-102143

(51) Int. Cl. B60C 15/00; D07B 1/06

(52) U.S. Cl. 152/539; 428/592; 29/527.2

(57) ABSTRACT

A method for manufacturing a bead cord wire includes the steps of subjecting a steel wire to a descaling treatment, subjecting the descaling-treated steel wire to a chemical conversion coating treatment through electrolysis so as to form a phosphate coating on a surface of the steel wire, and subjecting the chemical-conversion-coating-treated steel wire to drawing so as to produce a bead cord wire. In producing the bead cord wire, the drawing is conducted in such a way that the phosphate coating remains on the surface of the bead cord wire.

### TECHNICAL FIELD

The present invention relates to a method for manufacturing a bead cord wire to be used as a reinforcing material of, for example, a bead portion of a vehicle tire, as well as a bead cord and a vehicle tire.

### BACKGROUND ART

A method described in, for example, Patent Document 1 is known as a method for manufacturing a bead cord to be used as a reinforcing material of a bead portion of a vehicle tire. In the method described in Patent Document 1, a bead wire rod is made into a steel wire by drawing. Thereafter, the resulting steel wire is sequentially subjected to copper and zinc plating treatments so as to effect thermal diffusion of copper and zinc.

Patent Document 1: Japanese Patent No. 2872682

### DISCLOSURE OF INVENTION

### Problems to be Solved by the Invention

However, in the above-described known technology, a Cu alloy-based plating treatment is conducted in order to obtain adhesion to a tire (rubber). Therefore, an increase of materials cost results. Furthermore, when a bead cord composed of a wire subjected to a plating treatment is incorporated into a perimeter portion of a rim of a vehicle tire, a vulcanization accelerator or the like must be added to the rubber for facilitating vulcanization bonding between the metal (plating layer) and the rubber. Consequently, the cost further increases.

It is an object of the present invention to provide a method for manufacturing a bead cord wire, wherein the bead cord wire having excellent adhesion to rubber can be obtained without conducting a plating treatment, as well as a bead cord and a vehicle tire.

### Means for Solving the Problems

A method for manufacturing a bead cord wire according to an aspect of the present invention is characterized by including the steps of subjecting a steel wire to a descaling treatment, subjecting the descaling-treated steel wire to a chemical conversion coating treatment through electrolysis so as to form a phosphate coating on a surface of the steel wire, and subjecting the chemical-conversion-coating-treated steel wire to drawing so as to produce a bead cord wire, wherein in producing the bead cord wire, the drawing is conducted in such a way that the phosphate coating remains on the surface of the bead cord wire.

In the method for manufacturing a bead cord wire according to an aspect of the present invention, as described above, the phosphate coating is formed on the surface of the steel wire by the chemical conversion coating treatment through electrolysis. As a result, the steel wire having lubricity and corrosion resistance can be produced. In application of the drawing to the chemical-conversion-coating-treated steel wire, the drawing is conducted in such a way that the phosphate coating remains on the surface. Therefore, the corrosion resistance of the resulting bead cord wire is ensured to some extent. In this manner, the bead cord wire having excellent adhesion to rubber can be obtained because of intervention of the adhesive without specifically applying the plating treatment to the steel wire.

In producing the bead cord wire, preferably, the chemical-conversion-coating-treated steel wire is subjected to dry drawing and, thereafter, is subjected to wet drawing.

In the dry drawing, the amount of usage of lubricant is larger than that in the wet drawing. Therefore, if merely the dry drawing is applied to the steel wire, large amounts of dry-drawing lubricant may remain on the phosphate coating, and an influence may be exerted on the adhesion between the bead cord wire and the rubber. On the other hand, in the case where the wet drawing, in which the amount of usage of wet-drawing lubricant is small, is conducted after the dry drawing is conducted, the dry-drawing lubricant adhered to the phosphate coating falls off or is removed by dissolution. Consequently, the dry-drawing lubricant remaining on the phosphate coating can be reduced satisfactorily.

In the application of the wet drawing, preferably, the drawing is conducted in such a way that the ratio of the area reduction rate of the wet drawing to the area reduction rate of the entire drawing becomes 10% to 49%.

In the case where the ratio of the area reduction rate of the wet drawing is 10% or more, the dry-drawing lubricant adhered to the phosphate coating during the dry drawing falls off or is removed by dissolution satisfactorily. The ratio of the area reduction rate of the wet drawing is specified to be 49% or less and, thereby, the phosphate coating is prevented from falling off or being removed by dissolution, besides the dry-drawing lubricant adhered to the phosphate coating. Consequently, the corrosion resistance of the bead cord wire can be further improved. Furthermore, since the lubrication effect in the wet drawing can be ensured satisfactorily, an increase in surface roughness of the bead cord wire can be suppressed.

Preferably, the dry drawing and the wet drawing are conducted continuously in such a way that the steel wire is drawn in the same direction.

In the case where the dry drawing and wet drawing are conducted separately, the dry-drawn steel wire is once taken up around a bobbin and, thereafter, the steel wire is unwound from the bobbin so as to be wet-drawn. As a result, the directions of drawing (drawing directionality) applied to the same steel wire become opposite to each other. In this case, during the wet drawing conducted after the dry drawing, the phosphate coating easily falls off because the resistance increases. Therefore, the dry drawing and the wet drawing are conducted continuously in such a way that the steel wire is drawn in the same direction and, thereby, the resistance generated during the wet drawing is reduced. Consequently, falling off of the phosphate coating can be suppressed.

Preferably, a zinc phosphate coating is formed as the phosphate coating. Zinc phosphate has particularly excellent corrosion resistance among phosphates, and exhibits high versatility in the chemical conversion coating treatment through electrolysis. Therefore, it is favorable that the zinc phosphate coating is formed on the surface of the steel wire.

A bead cord according to an aspect of the present invention is characterized by including a circular core wire and a side wire helically wound around the circular core wire, wherein the side wire is composed of the bead cord wire produced by the above-described method for manufacturing a bead cord wire.

In the case where the side wire is produced by the above-described method for manufacturing a bead cord wire, as described above, the phosphate coating remains on the surface of the side wire, so that the corrosion resistance of the side wire is ensured to some extent. Consequently, the side wire is allowed to have excellent adhesion to rubber because of intervention of the adhesive without being specifically subjected to the plating treatment.

Preferably, a lubricating component containing a phosphate is adhered to a surface of the side wire, the surface roughness of the side wire is 0.2 to 12.0 μmRz, and the amount of adhesion of the lubricating component containing the phosphate to the surface of the side wire is 0.1 to 3.9 g/m².

The lubricating component containing the phosphate is allowed to reliably remain on the surface of the side wire by specifying the surface roughness of the side wire to be 0.2 μmRz or more. The surface roughness of the side wire of 12.0 μmRz or less can lead to good surface properties of the side wire regarding winding of the side wire. It was made clear from experiments and the like that a favorable amount of adhesion of the lubricating component containing the phosphate to the surface of the side wire was 0.1 to 3.9 g/m² to stabilize the surface roughness of the side wire for the long term.

Preferably, the material for the steel wire of the circular core wire is an alloy steel containing 0.08 to 0.27 percent by mass of C, 0.30 to 2.00 percent by mass of Si, 0.50 to 2.00 percent by mass of Mn, and 0.20 to 2.00 percent by mass of Cr; and further containing at least one type of Al, Nb, Ti, and V within the range of 0.001 to 0.100 percent by mass, the remainder being Fe and incidental impurities.

The above-described alloy steel has excellent weldability. Therefore, for example, in the case where the circular core wire is produced by welding both end surfaces of the core wire to each other, the weldability of both end surfaces of the core wire to each other becomes favorable by specifying the steel wire of the core wire to be the above-described alloy steel. Consequently, a reduction of strength of the connection portion of the circular core wire can be suppressed. As a result, a high strength bead cord can be produced.

The material for the steel wire of the circular core wire may be a carbon steel containing 0.28 to 0.56 percent by mass of C.

The above-described carbon steel has relatively excellent weldability. Therefore, for example, in the case where the circular core wire is produced by welding both end surfaces of the core wire to each other, the weldability of both end surfaces of the core wire to each other becomes favorable by specifying the steel wire of the core wire to be the above-described carbon steel. Consequently, a reduction of strength of the connection portion of the circular core wire can be suppressed. As a result, a high strength bead cord can be produced.

A vehicle tire according to an aspect of the present invention is characterized by including the above-described bead cord, wherein the bead cord is in the state of being coated with an adhesive and is embedded in a bead portion.

As described above, the side wire of the bead cord is allowed to ensure surface properties required for keeping the adhesion to rubber by using the above-described bead cord without being specifically subjected to the plating treatment. Therefore, the adhesion between the bead cord and the tire rubber can be made favorable by using an adhesive suitable for adhesion between a metal and rubber.

### ADVANTAGES

According to the present invention, a bead cord wire having excellent adhesion to the rubber can be obtained without application of the plating treatment. Consequently, costs required for producing the bead cord and incorporating the bead cord into a vehicle tire can be reduced.

### BRIEF DESCRIPTION OF THE DRAWINGS

FIG. 1 is a sectional view showing a vehicle tire provided with a bead cord according to an embodiment of the present invention.

FIG. 2 is a perspective view of the bead cord as shown in FIG. 1.

FIG. 3 is a magnified partial perspective view of the bead cord as shown in FIG. 2.

FIG. 4 is a sectional view of the bead cord as shown in FIG. 1.

FIG. 5 is a schematic diagram showing a ten-point average roughness (Rz) as the surface roughness of the circular core wire and the side wire as shown in FIG. 3.

FIG. 6 is a flow chart showing a procedure in which the bead cord, as shown in FIG. 3, is produced and incorporated into a vehicle tire.

FIG. 7 is a schematic diagram showing a method for conducting the dry drawing and the wet drawing as shown in FIG. 6.

FIG. 8 is a perspective view showing a manner in which the side wire is wound around the circular core wire as shown in FIG. 3.

FIG. 9 is a flow chart showing a known general procedure, in which a bead cord is produced and incorporated into a vehicle tire, as Comparative example.

### REFERENCE NUMERALS

1: vehicle tire, 6: bead portion, 9: bead cord, 10: circular core wire, 11: side wire (bead cord wire).

### BEST MODE FOR CARRYING OUT THE INVENTION

Preferred embodiments of a method for manufacturing a bead cord wire, a bead cord, and a vehicle tire according to the present invention will be described below with reference to the drawings.

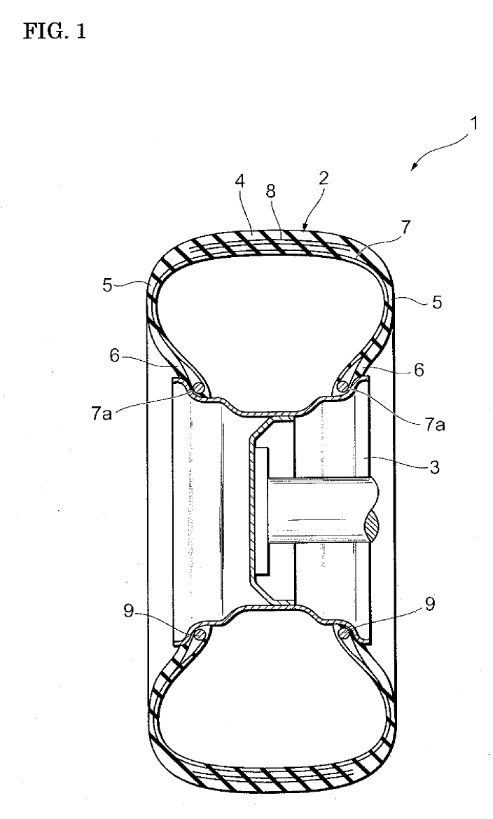

FIG. 1 is a sectional view showing a vehicle tire provided with a bead cord according to an embodiment of the present invention. In FIG. 1, the vehicle tire 1 is provided with a tire main body 27 and a rim 3 is mounted on this tire main body 2. The tire main body 2 has a tread portion 4, a pair of side wall portions 5 extending from both end portions of the tread portion 4 inward in the tire radius direction, and a pair of bead portions 6 fitted into the rim 3.

A carcass 7 and a plurality of layers of belts 8 are embedded in the inside of the tire main body 2. The carcass 7 is disposed from the tread portion 4 through each side wall 5 to each bead portion 6. The both end portions of the carcass 7 are folded back at respective bead portions 6. The belts 8 are disposed outside the carcass 7 in the tire radius direction in the tread portion.

A circular bead cord 9 is embedded in each bead portion 6 in such a way as to extend in a circumferential direction of the tire. The bead cord 9 is a reinforcing material for reinforcing the bead portion 6, and is disposed in such a way as to engage with the folded-back portion 7a of the carcass 7.

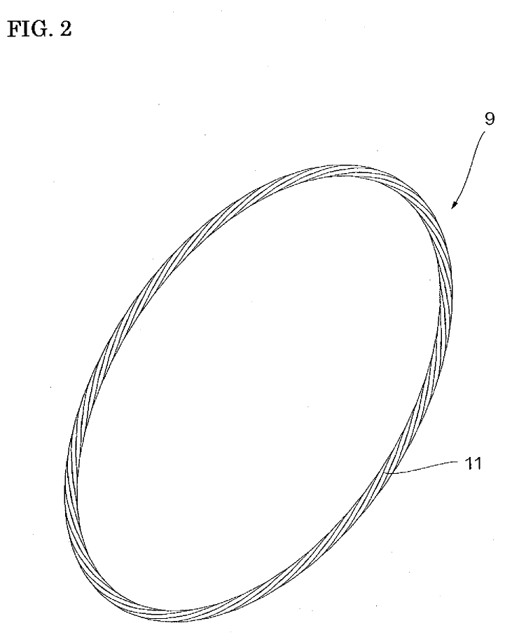

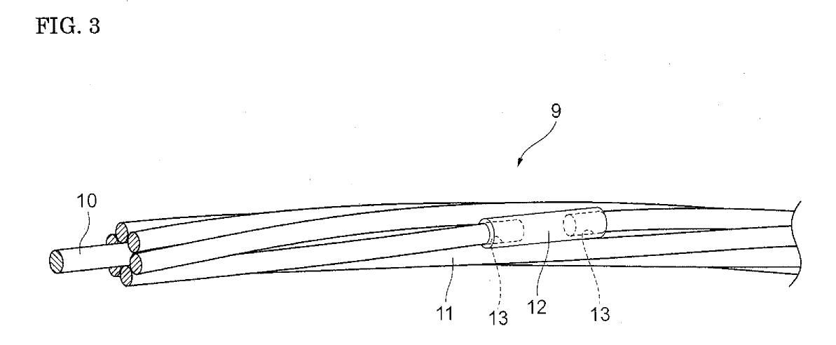

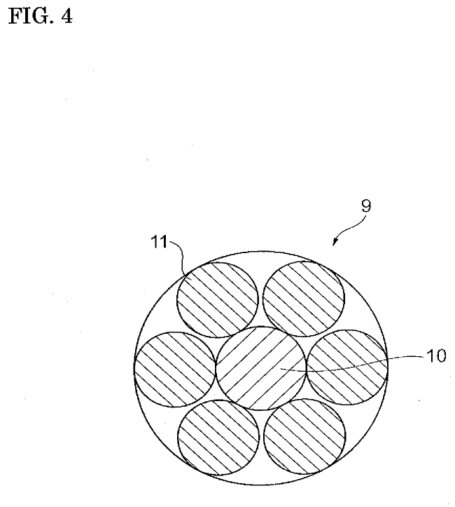

FIG. 2 is a perspective view of the bead cord 9, FIG. 3 is a magnified partial perspective view of the bead cord 9, and FIG. 4 is a magnified sectional view of the bead cord 9.

In each drawing, the bead cord 9 includes a circular core wire 10 and a side wire 11 continuously helically wound around the circular core wire 10. The wire diameter of the circular core wire 10 is larger than or equal to the wire diameter of the side wire 11. For example, the wire diameter of the circular core wire 10 is 1.5 mm, and the wire diameter of the side wire 11 is 1.4 mm.

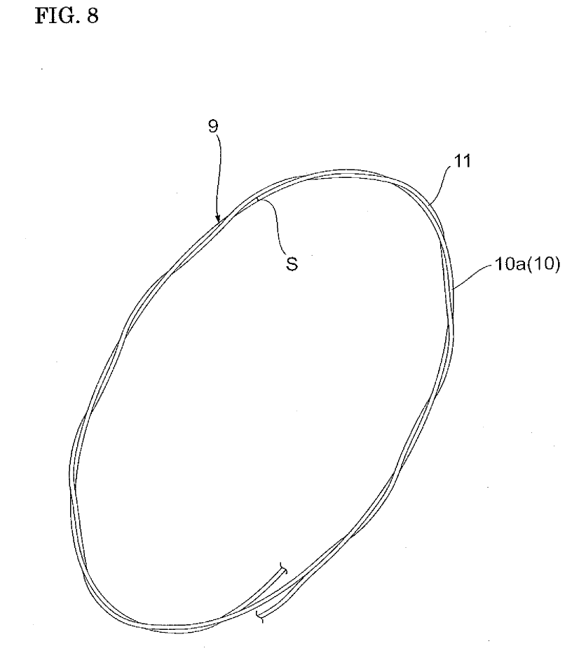

The circular core wire 10 is produced by circularly bending one core wire 10a and joining both end surfaces of the core wire 10a to each other through welding (refer to FIG. 8). In this case, both end surfaces of the core wire 10a can easily be joined to each other without increasing the diameter of the joint portion S of the circular core wire 10 (refer to FIG. 8).

The circular core wire 10 is formed from an alloy steel wire. The material for the alloy steel wire contains, for example, 0.08 to 0.27 percent by mass of C, 0.30 to 2.00 percent by mass of Si, 0.50 to 2.00 percent by mass of Mn, and 0.20 to 2.00 percent by mass of Cr, and further contains at least one type of Al, Nb, Ti, and V within the range of 0.001 to 0.100 percent by mass, the remainder being Fe and incidental impurities. The above-described composition improves the weldability of both end surfaces of the core wire 10a with each other. As a result, a reduction of breaking strength of the circular core wire 10 can be suppressed.

The circular core wire 10 may be formed from a carbon steel wire rod containing 0.28 to 0.56 percent by mass of C. Even in the case where the above-described carbon steel wire rod is used, the weldability of both end surfaces of the core wire 10a with each other is improved. Consequently, the strength required of the circular core wire 10 can be ensured.

The side wire 11 is helically wound a plurality of turns around the circular core wire 10. The side wire 11 is formed from a material that is a high-carbon steel wire rod containing 0.7 percent by mass or more of C.

The winding start edge portion and the winding end edge portion of the side wire 11 are connected to each other with a nearly cylindrical connection component 12. The connection component 12 has a pair of connection concave portions 13, into which the winding start edge portion and the winding end edge portion of the side wire 11 are inserted respectively, at both end sides. The connection concave portions 13 have a cross section in the shape of a circle. The connection component 12 may be merely a sleeve or the like.

A lubricating component containing a phosphate is adhered to the surfaces of the circular core wire 10 and the side wire 11, although not shown in the drawing. The lubricating component is a phosphate coating (described later) formed on the surfaces of the core wire 10a and the side wire 11 before drawing, and besides, a small amount of lubricant (described later) used during drawing may be included. Preferably, the amount of adhesion of lubricating component containing the phosphate is 0.1 to 3.9 g/m².

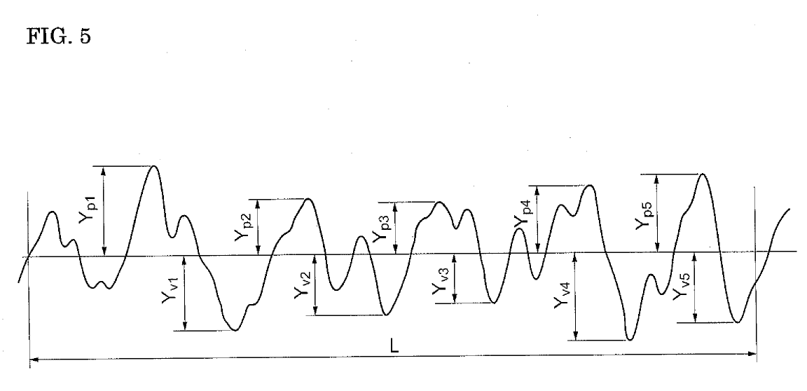

Preferably, the surface roughness of the circular core wire 10 and the side wire 11 is 0.2 to 12.0 μmRz. Here, the surface roughness refers to a ten-point average roughness (Rz) based on the standard of JIS B 0601-1994. Specifically, as shown in FIG. 5, a reference length L of curve is drawn from the roughness curve, and the ten-point average roughness (Rz) is determined by summing an average value of absolute values of altitude (Yp) of the first to the fifth highest crests above an average line of the drawn curve and an average value of absolute values of altitude (Yv) of the first to the fifth deepest troughs.

$$Rz = \frac{\begin{matrix}\vert {Yp}_{1} + {Yp}_{2} + {Yp}_{3} + {Yp}_{4} + {Yp}_{5} \vert + \\ \vert {Yv}_{1} + {Yv}_{2} + {Yv}_{3} + {Yv}_{4} + {Yv}_{5} \vert\end{matrix}}{5} \qquad [ Equation 1 ]$$

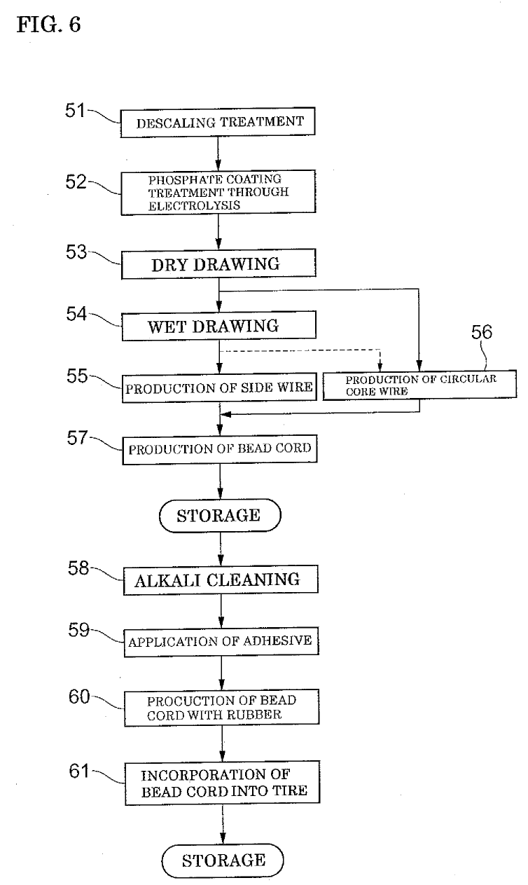

A method for producing the above-described bead cord 9 and incorporating the bead cord 9 into the tire main body 2 of the vehicle tire 1 will be described below with reference to a flow chart as shown in FIG. 6.

In FIG. 6, a steel wire for forming the circular core wire 10 and a steel wire for forming the side wire 11 are prepared. These steel wires are subjected to a descaling treatment (step 51). The descaling treatment includes not only a treatment for removing scales on the steel wire surface by a chemical or mechanical method, but also the following pickling treatment.

The descaling-treated steel wire is subjected to a chemical conversion coating treatment through electrolysis so as to form a phosphate coating having both the lubricity and the corrosion resistance on a surface of the steel wire (step 52). Here, a zinc phosphate coating is formed as the phosphate coating. The zinc phosphate coating has excellent corrosion resistance and exhibits high versatility in the chemical conversion coating treatment through electrolysis. Specifically, a phosphate-coating-forming solution containing predetermined amounts of, for example, zinc ion, phosphate ion, and nitrate ion is used as an electrolytic solution, a current is passed while the steel wire is allowed to serve as a cathode and, thereby, the zinc phosphate coating is formed as the phosphate coating. At this time, a uniform zinc phosphate coating can be formed stably on the steel wire surface by conducting the chemical conversion coating treatment through an electrolysis system.

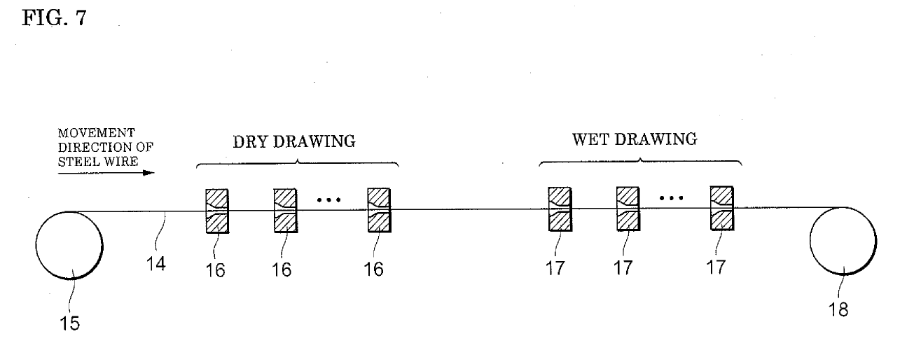

The steel wire chemical-conversion-coating-treated through electrolysis is subjected to dry drawing (step 53). Specifically, as shown in FIG. 7, the steel wire 14 resulting from the chemical conversion coating treatment is unwound from a reel 15, and is drawn through a dry-drawing dice 16 having a plurality of stages, so that the diameter of the steel wire 14 is sequentially reduced. At this time, in order to improve the lubricity of the steel wire 14 with respect to the dry-drawing dice 16, the drawing is conducted in the state in which the zinc phosphate coating formed on the steel wire 14 is covered with a dry-drawing lubricant and a pressure is applied. For the dry-drawing lubricant, a Ca-based metal soap (calcium stearate or the like) or a Na-based metal soap (sodium stearate or the like) is used.

The dry-drawn steel wire 14 is subjected to wet drawing serving as finish drawing so as to produce a steel wire (bead cord wire) having a desired diameter (stop 54). Specifically, as shown in FIG. 7, the steel wire 14 passed through the final stage of the dry-drawing dice 16 is drawn through a wet-drawing dice 17 having a plurality of stages, so that the diameter of the steel wire 14 is sequentially further reduced. At this time, in order to improve the lubricity of the steel wire 14 with respect to the wet-drawing dice 17, the drawing is conducted in the state in which the steel wire 14 is immersed in a wet-drawing lubricant. For the wet-drawing lubricant, for example, an aliphatic acid aqueous solution or the like is used.

At this time, since the uniform zinc phosphate coating is formed on the surface of the steel wire 14 by the above-described chemical conversion coating treatment through the electrolysis, the dry-drawing dice 16 and the wet-drawing dice 17 are difficult to damage during the drawing of the steel wire 14, and an improvement of drawability of the steel wire 14 can be facilitated.

In the dry drawing, large amounts of dry-drawing lubricant is required. Therefore, the dry-drawing lubricant may remain on the zinc phosphate coating after the drawing is completed. However, the wet drawing is conducted after the dry drawing is conducted. Consequently, an unnecessary dry-drawing lubricant adhered on the zinc phosphate coating falls off during passage through the wet-drawing dice 17 or is removed by dissolution with the wet-drawing lubricant.

In the application of the wet drawing, preferably, the drawing is conducted in such a way that the ratio of the area reduction rate of the wet drawing to the area reduction rate of the entire drawing becomes 10% to 49%. Here, the area reduction rate of the drawing is represented by the following equation where the wire diameter of the steel wire before the drawing is assumed to be d₀ and the wire diameter of the steel wire after the drawing is assumed to be d₁.

$$area reduction rate of drawing ( \% ) = \frac{( {d}_{0}^{2} - {d}_{1}^{2} )}{{d}_{0}^{2}} \times 100 \qquad [ Equation 2 ]$$

In this manner, falling off and removal by dissolution of the dry-drawing lubricant adhered to the zinc phosphate coating are facilitated, whereas removal of the zinc phosphate coating can be prevented. Therefore, an increase in surface roughness of the bead cord wire produced by finish drawing can be suppressed.

In the wet drawing, preferably, the surface roughness of the bead cord wire is adjusted to be 0.2 to 12.0 μmRz, and the amount of adhesion of the lubricating component containing zinc phosphate to the bead cord wire is adjusted to be 0.1 to 3.9 g/m². In the case where the surface roughness (Rz) of the wire is specified to be within the above-described range, the zinc phosphate coating is allowed to reliably remain on the surface of the bead cord wire, the bead cord wire is allowed to have good surface properties, and the surface of the bead cord wire is allowed to exhibit good lubricity.

As shown in FIG. 7, preferably, the dry drawing and the wet drawing are conducted continuously while the movement direction of the steel wire 14 is kept in the same direction (forward direction). In this manner, the direction of drawing (drawing directionality) applied to the steel wire 14 in the dry drawing becomes the same as that in the wet drawing. Therefore, the resistance generated between the steel wire 14 and the wet-drawing dice 17 during the wet drawing conducted after the dry drawing is reduced, so that the drawing of the steel wire 14 is conducted smoothly. Consequently, falling off of the zinc phosphate coating due to the resistance generated between the steel wire 14 and the wet-drawing dice 17 can be suppressed.

According to adoption of a combined drawing system in which the dry drawing and the wet drawing are conducted in combination, the zinc phosphate coating having the corrosion resistance is allowed to remain on the surface of the bead cord wire.

The bead cord wire produced by the above-described dry and the wet drawing and having a desired diameter is taken up around a reel 18, so that the side wire 11 having a desired diameter is formed (step 55).

At the same time, a steel wire produced by merely the above-described dry drawing and having a desired diameter is taken up around another reel, so that the core wire 10a having a coil diameter larger than the coil diameter of the side wire 11 is formed. The resulting core wire 10a is cut into a predetermined length. Thereafter, both end surfaces of the core wire 10a are butted against one another and are heat-welded. In this manner, the circular core wire 10 as shown in FIG. 8 can be produced (step 56). Regarding the method for forming the core wire 10a, if necessary, the wet drawing may be conducted after the dry drawing is conduced, as in the formation of the side wire 11 (indicated by an arrow made in a broken line, as shown in FIG. 6).

A wire winding machine, although not shown in the drawing, is used. As shown in FIG. 8, the side wire 11 is helically wound a plurality of turns around the circular core wire 10. At this time, as described above, since the surface of the side wire 11 has good lubricity, the side wire can be systematically arranged relative to the circular core wire 10, and an improvement of moldability can be facilitated.

The winding start edge portion and the winding end edge portion of the side wire 11 are inserted into respective connection concave portions 13 of a connection component 12 and, thereby, the winding start edge portion and the winding end edge portion of the side wire 11 are connected to each other with the connection component 12 (refer to FIG. 3). In this manner, the circular bead cord 9 is completed (step 57). The thus produced circular bead cord 9 is stored temporarily. If rusting of the bead cord 9, most of all, the side wire 11, occurs in the temporary storage, a pickling step is required before the following alkali cleaning step. Therefore, the zinc phosphate coating is allowed to remain so as to suppress the occurrence of rusting.

The bead cord 9 is subjected to alkali cleaning (step 58), if necessary. Thereafter, an adhesive is applied to the surface of the side wire 11 of the bead cord 9 (step 59). For the adhesive, an adhesive (for example, registered trademark: Chemlok) suitable for adhesion between a metal and rubber is used. As a matter of course, it is not necessary that the zinc phosphate coating remains after the alkali cleaning.

A bead cord with rubber is produced, wherein the bead cord 9 is fixed to a rubber material (step 60). At this time, since the bead cord 9 is coated with the adhesive, the bead cord 9 and the rubber material are reliably adhered and fixed to each other without addition of a vulcanization accelerator for vulcanization-bonding the bead cord 9 and the rubber material. Subsequently, the resulting bead cord with the rubber is incorporated into the bead portion 6 of the vehicle tire 1 (step 61).

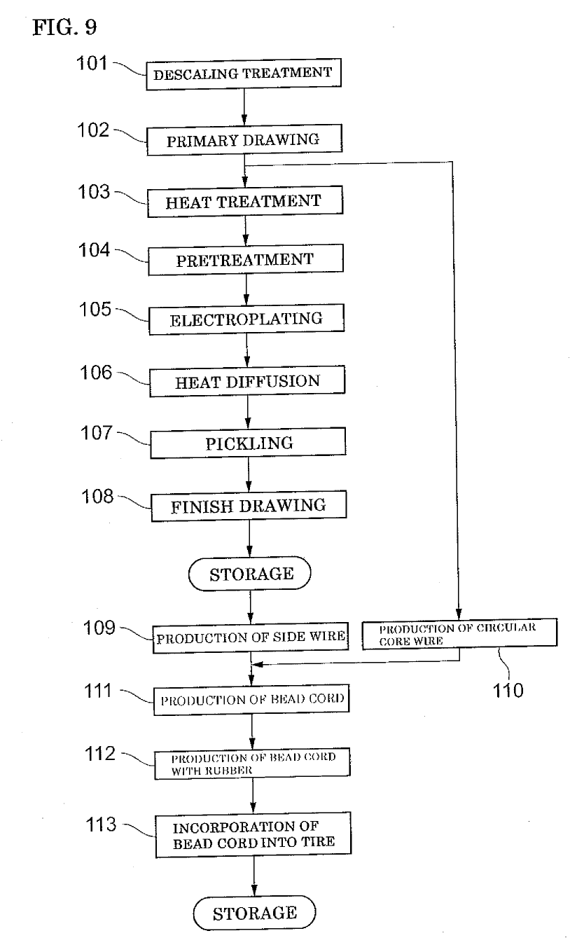

FIG. 9 shows a known general procedure, in which a bead cord is produced and incorporated into a tire main body 2, as Comparative example.

In FIG. 9, after a descaling treatment of the steel wire is conducted (step 101), the steel wire is subjected to primary drawing (step 102). Usually, the dry drawing is adopted as this primary drawing. After the steel wire subjected to the primary drawing is heat-treated at a low temperature (step 103), electrolysis, pickling, and the like of the steel wire are conducted as the pretreatment (step 104). The resulting steel wire is subjected to an electroplating treatment so as to sequentially form a copper plating layer and a zinc plating layer on the surface of the steel wire (step 105). Furthermore, the copper plating layer and the zinc plating layer are allowed to heat-diffuse by energization or high-frequency heating so as to form a brass plating layer (step 106).

The plated steel wire is pickled (step 107) and, thereafter, the resulting steel wire is subjected to secondary (finish) drawing (step 108). The dry drawing or the wet drawing is adopted as this secondary drawing.

The steel wire produced by the finish drawing is taken up around a reel, so that the side wire is formed (step 109). At the same time, the steel wire produced by the primary drawing is taken up around a reel so as to form a core wire. Both end surfaces of the core wire are connected to each other so as to produce a circular core wire (step 110). The side wire is helically wound a plurality of turns around the circular core wire. Furthermore, the winding start edge portion and the winding end edge portion of the side wire are connected to each other so as to produce a circular bead cord (step 111).

Subsequently, a rubber sheet containing a vulcanization accelerator is attached and, thereby, a bead cord with the rubber is produced (step 112). The bead cord with the rubber is incorporated into the bead portion 6 of the vehicle tire 1 (step 113).

In the above-described known general method for manufacturing a bead cord, since the surface of the steel wire is subjected to copper and zinc plating treatments, an increase of materials cost results. In addition to this, since addition of the vulcanization accelerator is required in the incorporation of the bead cord into the bead portion 6 of the vehicle tire 1, a large increase of the cost results.

On the other hand, in the present embodiment, the zinc phosphate coating having the corrosion resistance is formed on the surface of the steel wire by the chemical conversion coating treatment through electrolysis. Thereafter, the resulting steel wire is sequentially subjected to the dry drawing and the wet drawing in such a way that the zinc phosphate coating is allowed to remain on at least the surface of the side wire 11. Therefore, the corrosion resistance of the side wire 11 can be maintained even in the case where the steel wire is not subjected to a plating treatment. Consequently, the production cost can be reduced.

In the incorporation of the bead cord 9 composed of the circular core wire 10 and the side wire 11 into the bead portion 6 of the vehicle tire 1, excellent adhesion between the bead cord 9 and the rubber material can be realized by applying the adhesive suitable for adhering the metal and the rubber to the side wire 11. Therefore, the adhesion performance equivalent to that of the known product, in which the bead cord 9 and the rubber material are vulcanization-bonded, can be exhibited in spite of the low cost.

In this manner, the total cost required for the steps from the production of the bead cord 9 to the incorporation of the bead cord 9 into the vehicle tire 1 can be controlled at a low level.

The examples of the method for manufacturing a bead cord wire according to an aspect of the present invention will be described below.

The above-described method was used actually, and a steel wire was subjected to drawing so as to produce a bead cord wire (core wire and side wire). Furthermore, the resulting core wire and the side wire were used so as to produce a bead cord as shown in FIGS. 2 to 4. The materials for the steel wires of the core wire and the side wire are as shown in Table I.

TABLE I

| Bead cord | Wire rod | Chemical component (wt %) | | | | | | | |
|---|---|---|---|---|---|---|---|---|---|
| part of use | material | C | Si | Mn | Cr | P | S | Ti | Al |
| Circular | alloy steel | 0.17 | 0.93 | 1.50 | 0.41 | 0.013 | 0.006 | 0.08 | 0.03 |
| core wire | wire rod | | | | | | | | |
| Side wire | hard steel | 0.83 | 0.19 | 0.51 | — | 0.016 | 0.004 | — | — |
| | wire rod | | | | | | | | |

In the case where a medium carbon steel as shown in Table II is used as the material for the steel wire of the core wire as well, the performance nearly equivalent to the performance of those shown in Table 1 can be obtained.

TABLE II

| Bead cord | Wire rod | Chemical component (wt %) | | | | |
|---|---|---|---|---|---|---|
| part of use | material | C | Si | Mn | P | S |
| Circular core | medium carbon | 0.51 | 0.22 | 0.46 | 0.014 | 0.006 |
| wire | steel | | | | | |

The production condition of the core wire was as shown in Table III, and 6 types of core wires (No. 1 to No. 6) were produced. The production condition of the side wire was as shown in Table IV, and 10 types of side wires (No. 7 to No. 16) were produced.

TABLE III

| | | | Drawing condition | | | | |
|---|---|---|---|---|---|---|---|
| | | Amount of | Dry drawing condition | | | | Wet drawing |
| | | phosphate | | | Dry total | Dry final | condition |
| Drawing | Wire rod | coating through | | | area | dice | Lubricant |
| Condition | size | electrolysis | | Number | reduction | diameter | (concentration |
| No. | (φ mm) | (g/m²) | Lubricant | of dices | rate (%) | (mm) | 4% to 8%) |
| 1 | 5.0 | none | Na-based | 11 | 91.0 | 1.5 | — |
| | | | metal soap | | | | |
| 2 | 5.0 | none | Na-based | 7 | 81.5 | 2.15 | aliphatic acid |
| | | | metal soap | | | | aqueous |
| | | | | | | | solution |
| 3 | 5.0 | 25 | Na-based | 11 | 91.0 | 1.5 | — |
| | | | metal soap | | | | |
| 4 | 5.0 | 19 | Na-based | 7 | 81.5 | 2.15 | aliphatic acid |
| | | | metal soap | | | | aqueous |
| | | | | | | | solution |
| 5 | 5.0 | 32 | Na-based | 8 | 84.9 | 1.94 | aliphatic acid |
| | | | metal soap | | | | aqueous |
| | | | | | | | solution |
| 6 | 5.0 | 29 | Na-based | 9 | 87.5 | 1.77 | aliphatic acid |
| | | | metal soap | | | | aqueous |
| | | | | | | | solution |

| | |
|---|---|
| Drawing condition | |
| Wet drawing condition | Core wire property evaluation |

| | | Wet total | Ratio of area | Final | Wire | Amount of |
|---|---|---|---|---|---|---|
| Drawing | | area | reduction | wire | surface | residual |
| Condition | Number | reduction | rate of wet to | diameter | roughness | lubricant |
| No. | of dices | rate (%) | entire (%) | (mm) | (μmRz) | (g/m²) |
| 1 | 0 | — | — | 1.5 | 9.4 | 7.8 |
| 2 | 4 | 51.3 | 56.4 | 1.5 | 25.3 | 0.08 |
| 3 | 0 | — | — | 1.5 | 4.8 | 7.4 |
| 4 | 4 | 51.3 | 56.4 | 1.5 | 15.5 | 0.5 |
| 5 | 3 | 40.2 | 44.2 | 1.5 | 7.7 | 2.6 |
| 6 | 2 | 28.2 | 31.0 | 1.5 | 5.8 | 3.1 |

TABLE IV

| | | | Drawing condition | | | | |
|---|---|---|---|---|---|---|---|
| | | | Dry drawing condition | | | | Wet drawing |
| | Wire | Amount of phosphate | | | Dry total | Dry final | condition |
| Drawing | rod | coating through | | | area | dice | Lubricant |
| Condition | size | electrolysis | | Number | reduction | diameter | (concentration |
| No. | (φ mm) | (g/m²) | Lubricant | of dices | rate (%) | (mm) | 4% to 8%) |
| 7 | 4.5 | none | Na-based | 11 | 90.3 | 1.4 | — |
| | | | metal soap | | | | |
| 8 | 4.5 | none | Na-based | 9 | 86.4 | 1.66 | aliphatic acid |
| | | | metal soap | | | | aqueous |
| | | | | | | | solution |
| 9 | 4.5 | none | Na-based | 7 | 79.6 | 2.03 | aliphatic acid |
| | | | metal soap | | | | aqueous |
| | | | | | | | solution |
| 10 | 4.5 | 21 | Na-based | 6 | 75.0 | 2.25 | aliphatic acid |
| | | | metal soap | | | | aqueous |
| | | | | | | | solution |
| 11 | 4.5 | 19 | Na-based | 8 | 83.3 | 1.84 | aliphatic acid |
| | | | metal soap | | | | aqueous |
| | | | | | | | solution |
| 12 | 4.5 | 20 | Na-based | 9 | 86.4 | 1.66 | aliphatic acid |
| | | | metal soap | | | | aqueous |
| | | | | | | | solution |
| 13 | 4.5 | 31 | Na-based | 7 | 79.6 | 2.03 | aliphatic acid |
| | | | metal soap | | | | aqueous |
| | | | | | | | solution |
| 14 | 4.5 | 29 | Na-based | 8 | 83.3 | 1.84 | aliphatic acid |
| | | | metal soap | | | | aqueous |
| | | | | | | | solution |
| 15 | 4.5 | 30 | Na-based | 10 | 88.6 | 1.52 | aliphatic acid |
| | | | metal soap | | | | aqueous |
| | | | | | | | solution |
| 16 | 4.5 | 29 | Na-based | 10 + 1 | 90.3 | 1.4 | — |
| | | | metal soap | (skin pass) | | | |

| | Drawing condition | | | | | | |
|---|---|---|---|---|---|---|---|
| | Wet drawing condition | | | Side wire property evaluation | | | |
| | | Wet total | Ratio of area | Final | Wire | Amount of | |
| Drawing | | area | reduction | wire | surface | residual | |
| Condition | Number | reduction | rate of wet | diameter | roughness | lubricant | Corrosion |
| No. | of dices | rate (%) | to entire (%) | (mm) | (μmRz) | (g/m²) | resistance |
| 7 | 0 | — | — | 1.4 | 8.6 | 8.3 | Δ |
| 8 | 2 | 28.9 | 32.0 | 1.4 | 13.1 | 2.6 | X |
| 9 | 4 | 52.4 | 58.1 | 1.4 | 26.8 | 0.06 | X |
| 10 | 5 | 61.3 | 67.9 | 1.4 | 18.9 | 0.3 | Δ |
| 11 | 3 | 42.1 | 46.6 | 1.4 | 11.3 | 1.9 | ◯ |
| 12 | 2 | 28.9 | 32.0 | 1.4 | 6.7 | 2.4 | ⊙ |
| 13 | 4 | 52.4 | 58.1 | 1.4 | 12.9 | 0.7 | Δ |
| 14 | 3 | 42.1 | 46.6 | 1.4 | 7.5 | 2.5 | ⊙ |
| 15 | 1 | 15.2 | 16.8 | 1.4 | 1.6 | 3.7 | ⊙ |
| 16 | 0 | — | — | 1.4 | 3.4 | 3.3 | ⊙ |

Here, regarding the production condition of the core wire, the linear velocity after passing through the final stage dice is 650 m/min. Regarding the production condition of the side wire, the linear velocity after passing through the final stage dice is 700 m/min, and the area reduction rate of a skin pass is 8.2%. In the skin pass, dry drawing with the final stage dice is conducted by using merely the lubricant remaining on the wire surface without replenishing the lubricant.

Regarding the production condition of the bead cord, a maximum deviation angle of winding of the side wire is 23 degrees, the tension during unwinding of the side wire is 0.5 kg or less, the center diameter Dₛₒ of the circular core wire is 437.95 mm, and the ratio (Dₛₒ/D_{c}) of the center diameter Dₛₒ of the circular core wire to the center diameter D_{c} of the side wire is 0.64.

Bead cords were produced by combining the circular core wires produced under the drawing condition Nos. 1 to 6 shown in Table III and the side wires produced under the drawing condition Nos. 7 to 16 shown in Table IV, so as to evaluate the moldability and the corrosion resistance. The evaluation results at that time are shown in Tables IV and V. In Table IV, the evaluation results of the corrosion resistance of the side wire alone are indicated. In Table V, the evaluation results of the moldability and the corrosion resistance of the bead cord are indicated.

TABLE V

| | |
|---|---|
| Material used and | Bead cord evaluation |

| | |
|---|---|
| drawing condition No. | Corrosion |

| Circular core | Side wire | Moldability | resistance |
|---|---|---|---|
| 1 | 7 | ◯ | Δ |
| 1 | 8 | Δ | X |
| 1 | 9 | X | X |
| 1 | 10 | Δ | Δ |
| 1 | 11 | ⊙ | ◯ |
| 1 | 12 | ⊙ | ⊙ |
| 1 | 13 | Δ | Δ |
| 1 | 14 | ◯ | ⊙ |
| 1 | 15 | ⊙ | ⊙ |
| 1 | 16 | ⊙ | ⊙ |
| 2 | 7 | X | Δ |
| 2 | 8 | X | X |
| 2 | 9 | X | X |
| 2 | 10 | X | Δ |
| 2 | 11 | Δ | Δ |
| 2 | 12 | ◯ | ⊙ |
| 2 | 13 | X | X |
| 2 | 14 | Δ | ⊙ |
| 2 | 15 | ◯ | ⊙ |
| 2 | 16 | ◯ | ⊙ |
| 3 | 7 | ◯ | Δ |
| 3 | 9 | X | X |
| 3 | 12 | ⊙ | ⊙ |
| 3 | 13 | Δ | Δ |
| 3 | 15 | ⊙ | ⊙ |
| 4 | 7 | Δ | Δ |
| 4 | 8 | Δ | X |
| 4 | 9 | X | X |
| 4 | 10 | X | Δ |
| 4 | 11 | Δ | ◯ |
| 4 | 12 | ◯ | ⊙ |
| 4 | 13 | Δ | Δ |
| 4 | 14 | ◯ | ⊙ |
| 5 | 7 | ◯ | Δ |
| 5 | 8 | Δ | X |
| 5 | 9 | X | X |
| 5 | 10 | X | Δ |
| 5 | 11 | ◯ | ◯ |
| 5 | 12 | ⊙ | ⊙ |
| 5 | 13 | Δ | Δ |
| 6 | 7 | ◯ | Δ |
| 6 | 9 | X | X |
| 6 | 12 | ⊙ | ⊙ |
| 6 | 13 | ◯ | Δ |

Here, regarding the moldability, the tidiness of the side wire relative to the circular core wire was visually evaluated. The number of bead cords to be evaluated was 20 on a type of bead cord basis, and the evaluation criteria were as described below.

⊙: No irregular arrangement was observed with respect to all of 20 bead cords.

◯: No irregular arrangement was observed with respect to 18 or 19 bead cords.

Δ: No irregular arrangement was observed with respect to 10 to 17 bead cords,

x: No irregular arrangement was observed with respect to 9 or less of bead cords.

Regarding the corrosion resistance, the circular core wire and the side wire after finish drawing or the bead cord were stood under the condition of 30° C.×80% RH (corresponding to the rainy season), and evaluation was conducted on the basis of the time that elapsed before rusting was recognized. The evaluation criteria at this time were as described below.

⊙: 200 hours or more

◯: 120 hours or more, and less than 200 hours

Δ: 80 hours or more, and less than 120 hours

x: less than 80 hours

As is clear from the evaluation results shown in Tables IV and V, the corrosion resistance of the surface of the side wire is improved by forming the zinc phosphate coating on the surface of the steel wire by the chemical conversion coating treatment through electrolysis, and subjecting the resulting steel wire to at least the dry drawing. At this time, in the case where the ratio of the area reduction rate of the wet drawing to the area reduction rate of the entire drawing is specified to be 10% to 49%, the corrosion resistance of the surface of the side wire is maintained.

As is clear from the evaluation results shown in Table V, the moldability of the bead cord is improved by forming the zinc phosphate coating on the surface of the steel wire by the chemical conversion coating treatment through electrolysis, and subjecting the resulting steel wire to at least the dry drawing. At this time, in the case where the surface roughness of the side wire after the finish drawing is specified to be 0.2 to 12.0 μmRz, the moldability of the bead cord is improved.

In the above-described examples, the corrosion resistance of the side wire was ensured to some extent and deterioration of the moldability of the bead cord was able to be prevented without subjecting the steel wire to a plating treatment. Therefore, the effects of the present invention were demonstrated.

The present invention is not limited to the above-described embodiment. For example, in the above-described embodiment, the combined drawing system, in which the dry drawing and the wet drawing are continuously applied to the steel wire provided with the zinc phosphate coating, is adopted. However, merely the dry drawing may be conducted depending on the production condition and the like of the bead cord wire.

In the above-described embodiment, the zinc phosphate coating is formed on the surface of the steel wire by the chemical conversion coating treatment through electrolysis, the resulting steel wire is subjected to the drawing and, thereby, both the circular core wire 10 and the side wire 11 are produced. However, such the production method may be applied to at least the side wire 11.

Furthermore, in the configuration of the above-described embodiment, one layer of the side wire 11 is helically wound around the circular core wire 10. However, a plurality of layers of side wire 11 may be wound around the circular core wire 10. A stranded wire may be formed by stranding a plurality of circular core wires in place of the above-described circular core wire 10, and the side wire 11 may be helically wound around the resulting stranded wire.

1. A method for manufacturing a bead cord wire, the method comprising:
subjecting a steel wire to a descaling treatment;
subjecting the descaling-treated steel wire to a chemical conversion coating treatment through electrolysis so as to form a phosphate coating on a surface of the steel wire; and
subjecting the chemical-conversion-coating-treated steel wire to drawing so as to produce a bead cord wire,
wherein in producing the bead cord wire, the drawing is conducted in such a way that the phosphate coating remains on the surface of the bead cord wire.

2. The method for manufacturing a bead cord wire according to claim 1, wherein in producing the bead cord wire, the chemical-conversion-coating-treated steel wire is subjected to dry drawing and, thereafter, is subjected to wet drawing.

3. The method for manufacturing a bead cord wire according to claim 2, wherein in applying the wet drawing, the drawing is conducted in such a way that the ratio of the area reduction rate of the wet drawing to the area reduction rate of the entire drawing becomes 10% to 49%.

4. The method for manufacturing a bead cord wire according to claim 2, wherein the dry drawing and the wet drawing are conducted continuously in such a way that the steel wire is drawn in the same direction.

5. The method for manufacturing a bead cord wire according to claim 1, wherein a zinc phosphate coating is formed as the phosphate coating.

6. A bead cord, comprising
a circular core wire; and
a side wire helically wound around the circular core wire,
wherein the side wire is composed of the bead cord wire produced by the method for manufacturing a bead cord wire according to claim 1.

7. The bead cord according to claim 6, further comprising:
a lubricating component comprising a phosphate is adhered to a surface of the side wire,
wherein the surface roughness of the side wire is 0.2 to 12.0 μmRz, and
wherein the amount of adhesion of the lubricating component comprising the phosphate to the surface of the side wire is 0.1 to 3.9 g/m².

8. The bead cord according to claim 6, wherein the material for the steel wire of the circular core wire is an alloy steel comprising 0.08 to 0.27 percent by mass of C, 0.30 to 2.00 percent by mass of Si, 0.50 to 2.00 percent by mass of Mn, and 0.20 to 2.00 percent by mass of Cr, and further comprising at least one type of Al, Ti and V within the range of 0.001 to 0.100 percent by mass, the remainder being Fe and incidental impurities.

9. The bead cord according to claim 6, wherein the material for the steel wire of the circular core wire is a carbon steel comprising 0.28 to 0.56 percent by mass of C.

10. A vehicle tire comprising the bead cord according to claim 6, wherein the bead cord is in the state of being coated with an adhesive and is embedded in a bead portion.

11. The method for manufacturing a bead cord wire according to claim 3, wherein the dry drawing and the wet drawing are conducted continuously in such a way that the steel wire is drawn in the same direction.

12. The method for manufacturing a bead cord wire according to claim 2, wherein a zinc phosphate coating is formed as the phosphate coating.

13. The method for manufacturing a bead cord wire according to claim 3, wherein a zinc phosphate coating is formed as the phosphate coating.

14. The method for manufacturing a bead cord wire according to claim 4, wherein a zinc phosphate coating is formed as the phosphate coating.

15. A bead cord, comprising:
a circular core wire; and
a side wire helically wound around the circular core wire,
wherein the side wire is composed of the bead cord wire produced by the method for manufacturing a bead cord wire according to claim 2.

16. The bead cord according to claim 7, wherein the material for the steel wire of the circular core wire is an alloy steel comprising 0.08 to 0.27 percent by mass of C, 0.30 to 2.00 percent by mass of Si, 0.50 to 2.00 percent by mass of Mn, and 0.20 to 2.00 percent by mass of Cr, and further comprising at least one type of Al, Nb, Ti and V within the range of 0.001 to 0.100 percent by mass, the remainder being Fe and incidental impurities.

17. The bead cord according to claim 7, wherein the material for the steel wire of the circular core wire is a carbon steel comprising 0.28 to 0.56 percent by mass of C.

18. A vehicle tire comprising the bead cord according to claim 7, wherein the bead cord is in the state of being coated with an adhesive and is embedded in a bead portion.

19. A vehicle tire comprising the bead cord according to claim 8, wherein the bead cord is in the state of being coated with an adhesive and is embedded in a bead portion.

20. A vehicle tire comprising the bead cord according to claim 9, wherein the bead cord is in the state of being coated with an adhesive and is embedded in a bead portion.
